(19) United States
(12) Patent Application Publication
(10) Pub. No.: US 2025/0192462 A1
(43) Pub. Date: Jun. 12, 2025

(54) PLUG PRONG

(71) Applicant: TUN LI SU, KAOHSIUNG CITY (TW)

(72) Inventor: TUN LI SU, KAOHSIUNG CITY (TW)

(21) Appl. No.: 18/536,901

(22) Filed: Dec. 12, 2023

(51) Int. Cl. H01R 13/04

(52) U.S. Cl. CPC H01R 13/04

(57) ABSTRACT

A plug prong comprises a contact section configured to be inserted into a socket, a riveting section configured for wire connection via riveting, and a to-be-clamped section located between the contact section and the riveting section and configured to be clamped by an inner frame. The to-be-clamped section includes a neck having a notch which is open in a lateral side. The notch includes a recessed groove formed on a lower edge of the notch. The recessed groove includes a bottom edge located outside of an outermost face of the inner frame facing the contact section. After injection molding to form a plug product, the recessed groove will extend from an inner side to an outer side of an engagement face of the plug product.

### BACKGROUND OF THE INVENTION

The present invention relates to an electrical appliance connector and, more particularly, to a plug prong for an electrical appliance.

In the manufacture of a plug including prongs with insulating layers in the industry, the manufacturer of the prongs firstly produces continuous prongs in a bundle, with the continuous prongs being enveloped by an insulating layer via injection molding. Then, the continuous prongs are delivered to a second manufacturer in demand. The second manufacturer cut the prongs into separate insulating prongs each of which is then connected to a wire through riveting to form an individual insulating prong. Next, the insulating prongs are inserted through an inner frame having first and second through-holes (or even a third through-hole). Therefore, a hot prong and a neutral prong are inserted through the first and second through-holes, and an earth prong is inserted through the third through-hole. In this case, the insulating prongs have been engaged with the inner frame to form a semi-product of a plug. The semi-product is then placed into a plug mold to form a whole plug after injection molding. In another approach, the insulating prongs are not delivered in a bundle. Specifically, as shown in FIG. 16, individual prongs 4 after cutting are delivered to the manufacturer in demand.

However, regardless of the types of manufacturing, when using an injection molding machine to proceed with the first injection molding in a mold to form an inner frame with prongs, the following problems often occur. In a case that the injecting pressure of the injection molding machine is too large, a flaw of so-called “excessive material” (an excessive amount of plastic material is injected and, thus, overflows out of the predetermined range for the inner frame) often occurs. Thus, the excessively formed portion must be manually scraped off, which is laborsome and uneconomic. On the other hand, when the injecting pressure of the injection molding machine is insufficient, a flaw of so-called “lack of material” (the amount of injected plastic material is insufficient to support the inner frame and, thus, lacks material). This flaw resulting from lack of material is difficult to remedy and, thus, often fails to meet the safety regulations.

Thus, a need exists for a novel plug prong that mitigates and/or obviates the above drawbacks.

### BRIEF SUMMARY OF THE INVENTION

In view of the above drawbacks in the prior art, an objective of the present invention is to provide a plug prong comprising a contact section configured to be inserted into a socket, a riveting section configured for wire connection via riveting, and a to-be-clamped section located between the contact section and the riveting section and configured to be clamped by an inner frame. The to-be-clamped section includes a neck having a notch which is open in a lateral side. The notch includes a recessed groove formed on a lower edge of the notch. The recessed groove includes a bottom edge located outside of an outermost face of the inner frame facing the contact section. Thus, after injection molding to form a plug product, the recessed groove will extend from an inner side to an outer side of an engagement face of the plug product.

Thus, when the injection pressure of the injection molding machine is too large (which may incur the “excessive material” overflowing out of the predetermined range for the inner frame), the recessed groove can receive the excessive material to reduce the risk. Furthermore, in a case that “lack of material” exists in other portions, the plastic material accumulated in the recessed groove may provide fluidic supply to avoid lack of material in other portions.

In an example, the recessed groove intercommunicates with a guiding groove preformed in the to-be-clamped section.

In an example, the plug prong includes a plurality of catching pores formed in the to-be-clamped section.

In an example, the bottom edge of the recessed groove is an arcuate recession.

In an example, the bottom edge of the recessed groove includes three rectilinear sides forming a recession.

In an example, the bottom edge of the recessed groove includes two slant sides extending downward and toward each other.

In an example, the recessed groove includes a slant side, an arcuate side opposite to the slant side, and a recessed arcuate bottom side interconnected between the slant side and the arcuate side.

The present invention will become clearer in light of the following detailed description of illustrative embodiments of this invention described in connection with the drawings.

### DESCRIPTION OF THE DRAWINGS

FIG. 1 is a perspective view of a plug prong of an embodiment according to the present invention.

FIG. 2 is a partly-cutaway perspective view illustrating coupling of two plug prongs according to the present invention and an inner frame.

FIG. 3 is a diagrammatic side view of the plug prongs and the inner frame of FIG. 2.

FIG. 4 is a perspective view of an example of the plug prong according to the present invention.

FIG. 5 is a perspective view of another example of the plug prong according to the present invention.

FIG. 6 is a perspective view of a further example of the plug prong according to the present invention.

FIG. 7 is a perspective view of still another example of the plug prong according to the present invention.

FIG. 8 is a diagrammatic perspective view of a type of plug product using the plug prongs according to the present invention.

FIG. 9 is a diagrammatic perspective view of another type of plug product using the plug prongs according to the present invention.

FIG. 10 is a diagrammatic perspective view of a further type of plug product using the plug prongs according to the present invention.

FIG. 11 is a diagrammatic perspective view of still another type of plug product using the plug prongs according to the present invention.

FIG. 12-1 is a diagrammatic enlarged view illustrating an example of a recessed groove of the plug prong according to the present invention.

FIG. 12-2 is a diagrammatic enlarged view illustrating another example of the recessed groove of the plug prong according to the present invention.

FIG. 12-3 is a diagrammatic enlarged view illustrating a further example of the recessed groove of the plug prong according to the present invention.

FIG. 12-4 is a diagrammatic enlarged view illustrating still another example of the recessed groove of the plug prong according to the present invention.

FIG. 13 is a diagrammatic view illustrating a plug prong with another type of recessed groove of another embodiment according to the present invention.

FIG. 14 is a diagrammatic perspective view illustrating coupling of the plug prong according to the present invention and an inner frame of another type.

FIG. 15 is a diagrammatic perspective view illustrating coupling of the plug prong according to the present invention and an inner frame of a further type.

FIG. 16 is a diagrammatic view of a conventional plug prong.

### DETAILED DESCRIPTION OF THE INVENTION

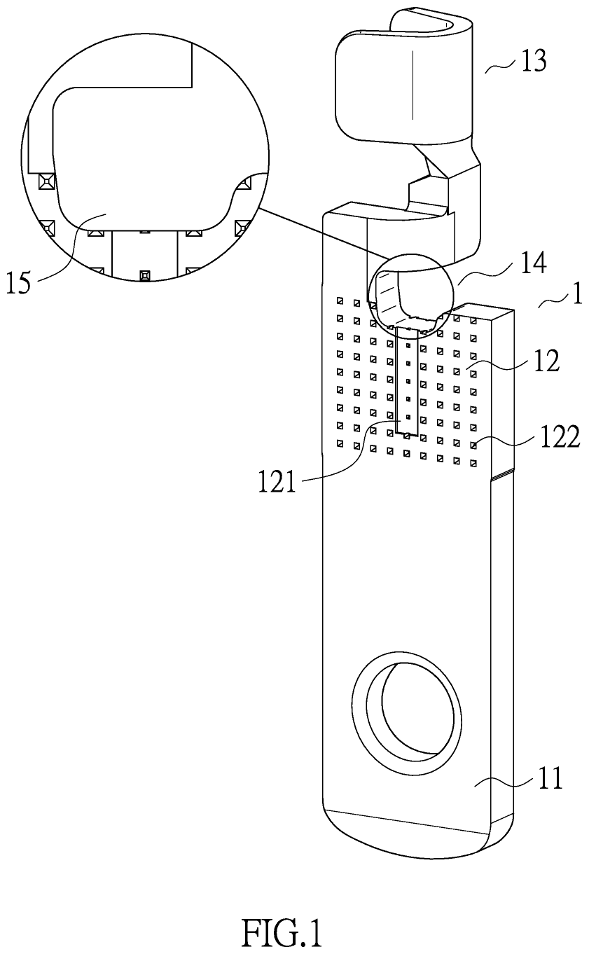

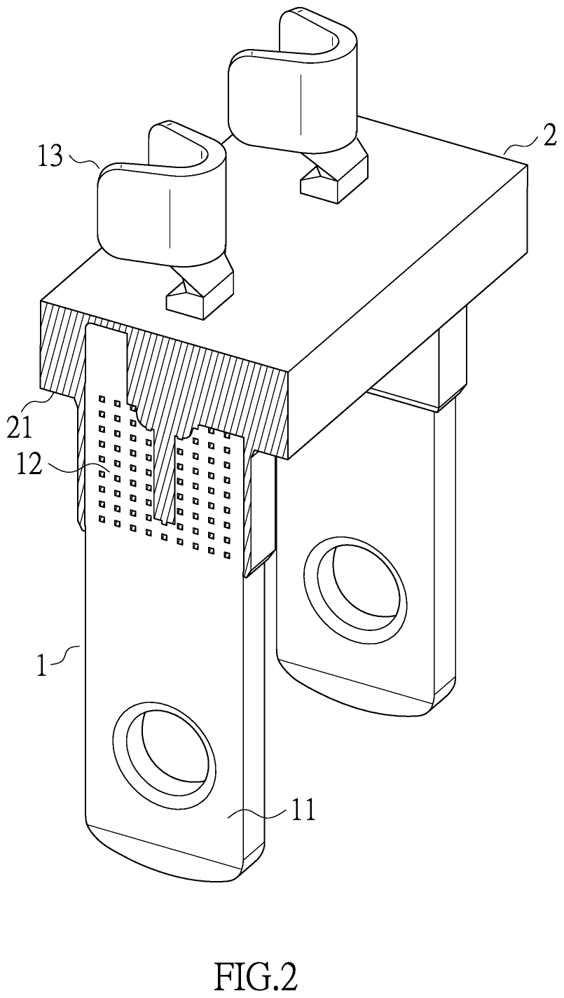

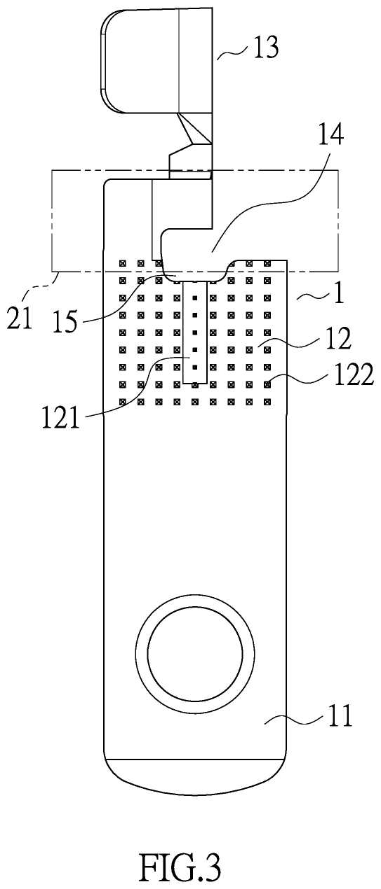

With reference to FIG. 1 illustrating a perspective view of a plug prong 1 according to the present invention and FIGS. 2-3 illustrating the plug prong 1 and an inner frame 2, the relationship and engagement between the plug prong 1 according to the present invention and the inner frame 2 can be appreciated.

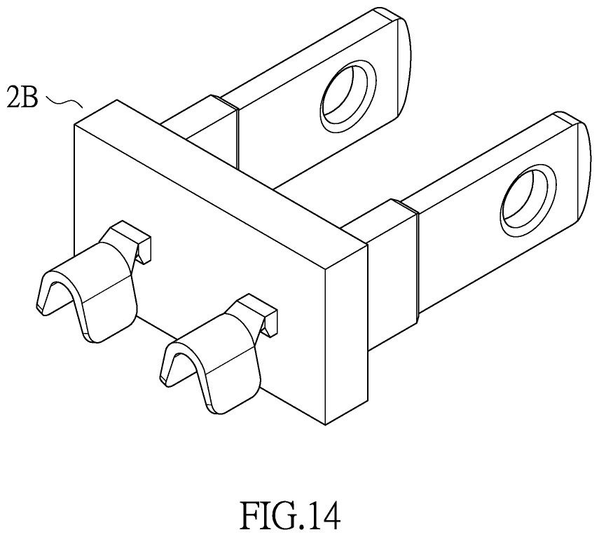

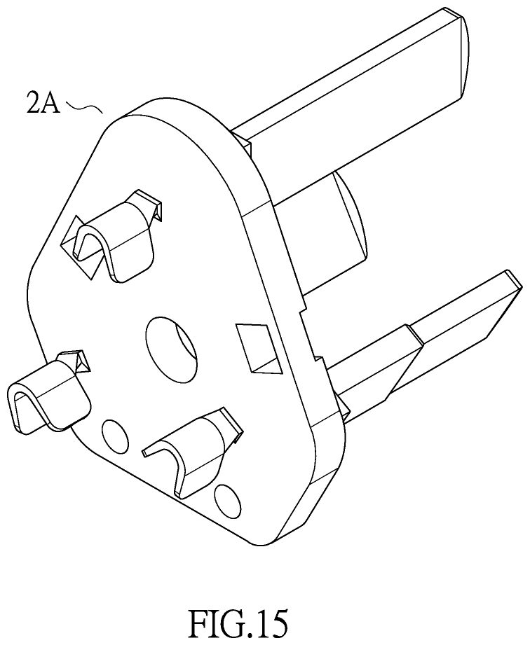

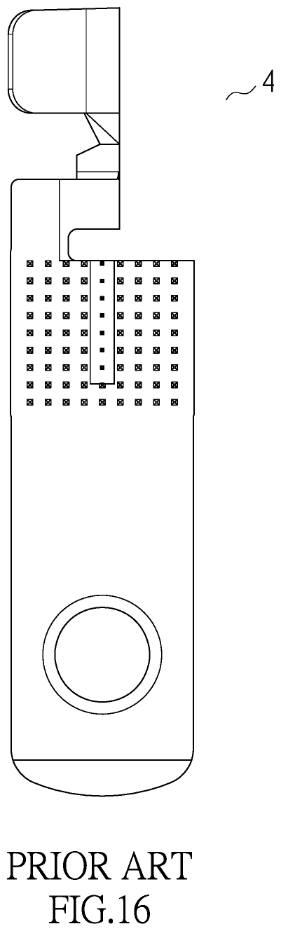

The plug prong 1 according to the present invention comprises a contact section 11 configured to be inserted into a socket, a riveting section 13 configured for wire connection via riveting, and a to-be-clamped section 12 located between the contact section 11 and the riveting section 13 and configured to be clamped by an inner frame 2. The inner frame may have various types, such as the inner frames 2A, 2B shown in FIGS. 14 and 15. Furthermore, each section of the plug prong 1 is disposed relative to the inner frame 2 in sequent procedures.

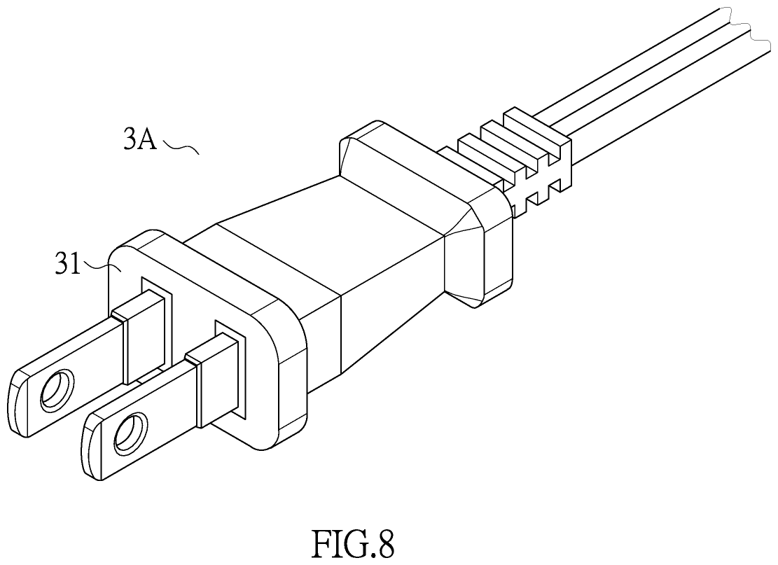

The to-be-clamped section 12 includes a neck having a notch 14 which is open in a lateral side. The notch 14 includes a recessed groove 15 formed on a lower edge of the notch 14. The recessed groove 15 includes a bottom edge located outside of an outermost face 21 of the inner frame 2 facing the contact section 11. Thus, after injection molding to form a plug product, the recessed groove 15 will extend from an inner side of an engagement face 31 of the plug product 3A to an outer side of the engagement face 31, as shown in FIG. 8.

The recessed groove 15 can absorb excessive plastic material to provide a buffering function, thereby reducing the risk of “excessive material”. In the case of lack of material, the plastic material accumulated in the recessed groove 15 can provide fluidic supply to avoid “lack of material” in other portions.

In a preferred embodiment shown in FIGS. 1-3, the recessed groove 15 intercommunicates with a guiding groove 121 preformed in the to-be-clamped section 12. Thus, the plastic material can flow smoothly. Therefore, even if the injecting pressure of an injection molding machine is smaller, the intercommunication reduces the resistance to the flow of the plastic material, which also solves the risk of “lack of material”. Furthermore, in the preferred embodiment according to the present invention, the plug prong 1 may include a plurality of catching pores 122 formed in the to-be-clamped section 12 to provide enhanced catching force of the plastic material.

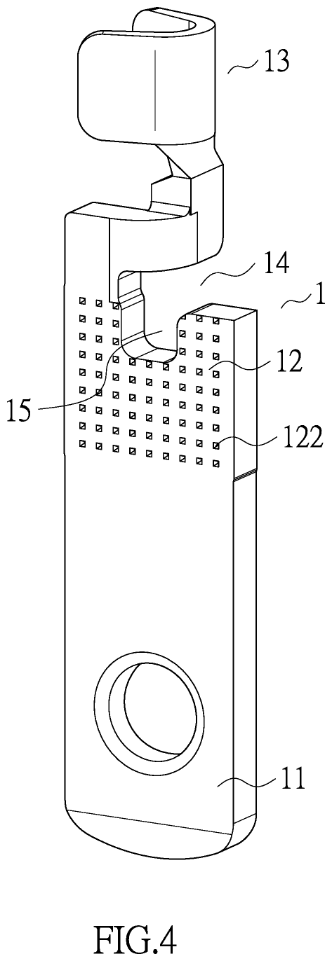

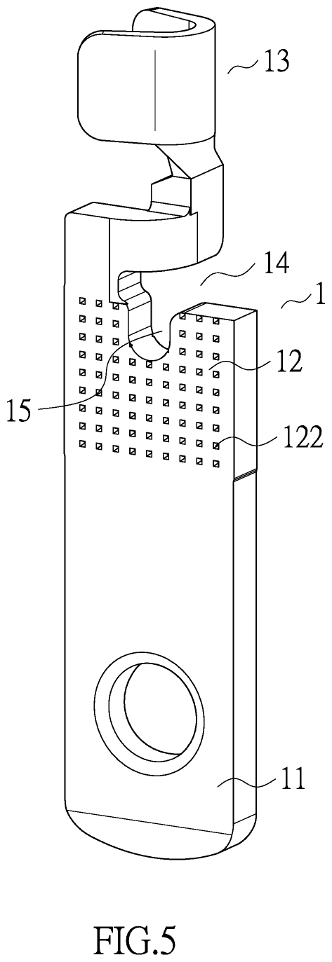

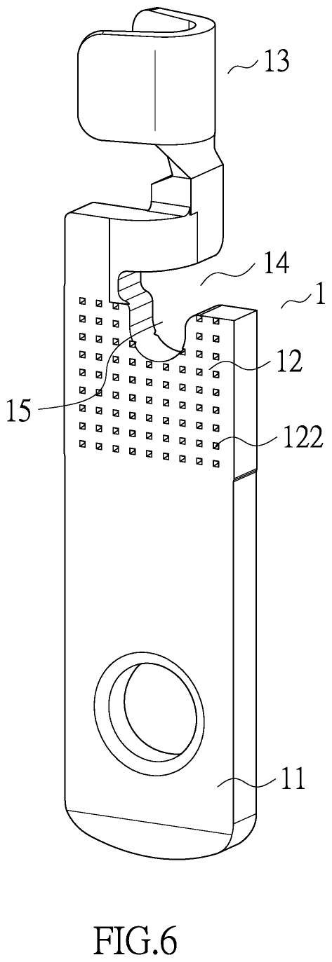

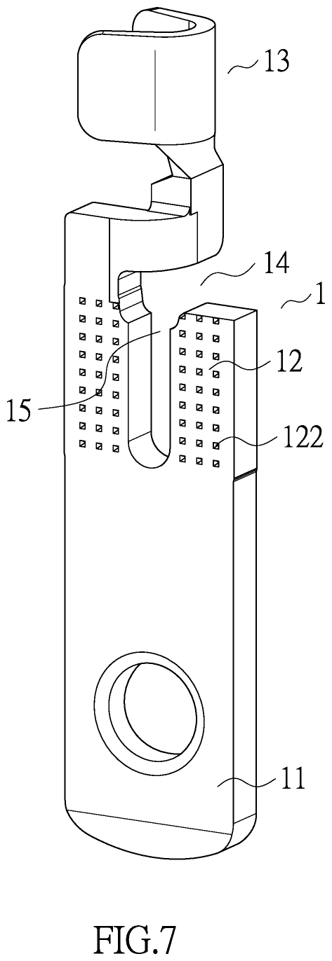

With reference to FIGS. 4-7, the plug prong 1 and its recessed groove 15 according to the present invention may have various forms without restriction to implementation of the present invention.

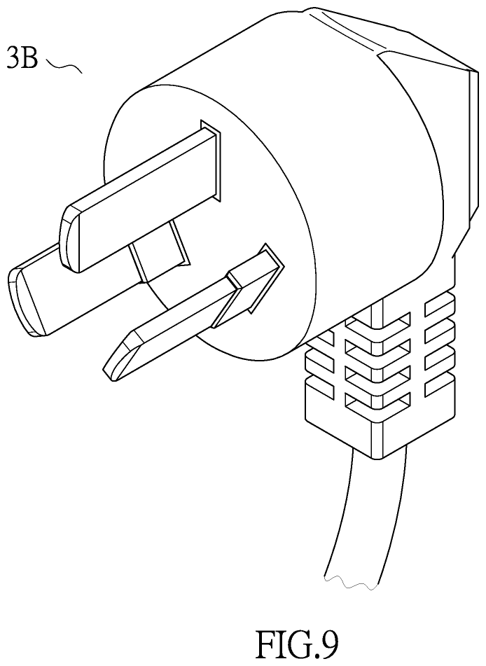

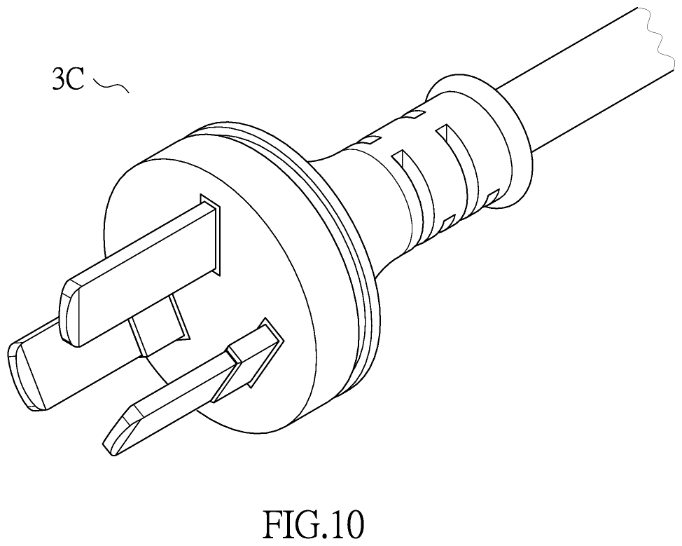

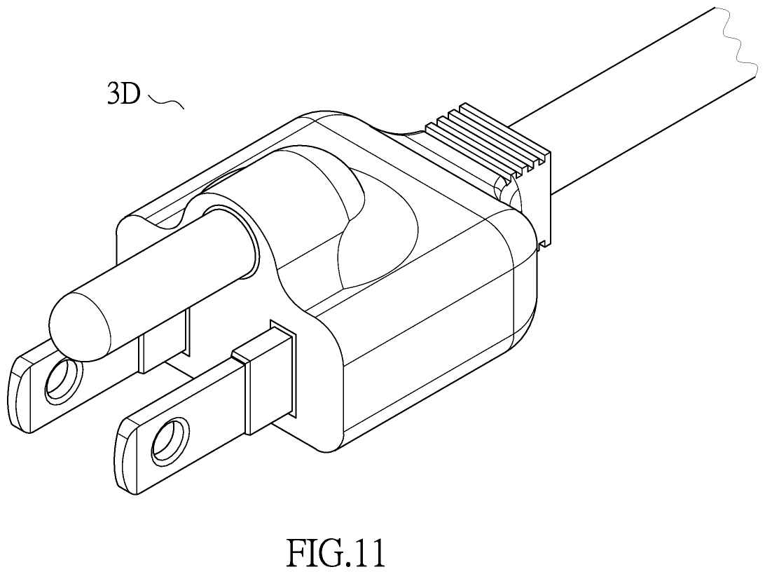

The present invention may be widely used in a plug product 3A shown in FIG. 8, a plug product 3B shown in FIG. 9, a plug product 3C shown in FIG. 10, or a plug product 3D shown in FIG. 1, thereby providing wider applications.

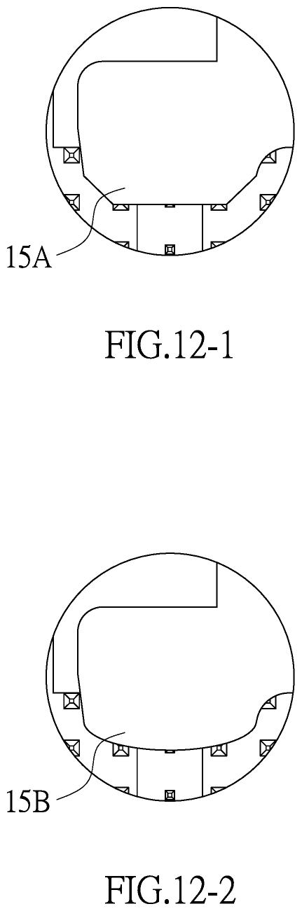

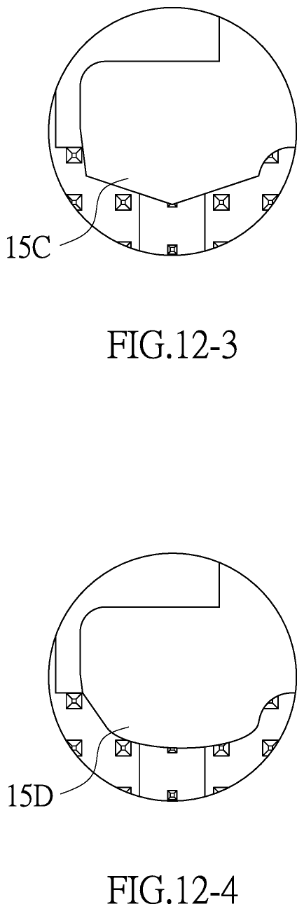

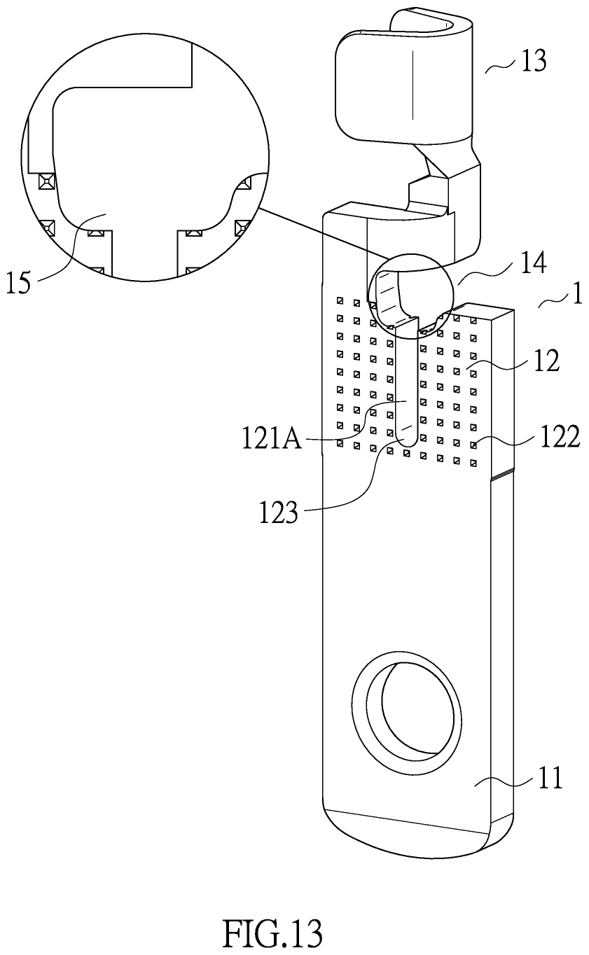

The recessed groove 15 may have various forms. In an example shown in FIG. 12-1, the bottom edge of the recessed groove 15A includes three rectilinear sides forming a recession. In another example shown in FIG. 12-2, the bottom edge of the recessed groove 15B is an arcuate recession. In a further example shown in FIG. 12-3, the bottom edge of the recessed groove 15C includes two slant sides extending downward and toward each other. In still another example shown in FIG. 12-4, the recessed groove 15D includes a slant side, an arcuate side opposite to the slant side, and a recessed arcuate bottom side interconnected between the slant side and the arcuate side. The recessed groove 15A-15D in each example has an increased volume to receive more plastic material to thereby provide an enhanced buffering function in reducing the risk of “excessive material”.

Although specific embodiments have been illustrated and described, numerous modifications and variations are still possible without departing from the scope of the invention. The scope of the invention is limited by the accompanying claims.

What is claimed is:

1. A plug prong comprising a contact section configured to be inserted into a socket, a riveting section configured for wire connection via riveting, and a to-be-clamped section located between the contact section and the riveting section and configured to be clamped by an inner frame, wherein the to-be-clamped section includes a neck having a notch which is open in a lateral side, wherein the notch includes a recessed groove formed on a lower edge of the notch, and wherein the recessed groove includes a bottom edge located outside of an outermost face of the inner frame facing the contact section.

2. The plug prong as claimed in claim 1, wherein the recessed groove intercommunicates with a guiding groove preformed in the to-be-clamped section.

3. The plug prong as claimed in claim 1, wherein the plug prong includes a plurality of catching pores formed in the to-be-clamped section.

4. The plug prong as claimed in claim 1, wherein the bottom edge of the recessed groove is an arcuate recession.

5. The plug prong as claimed in claim 1, wherein the bottom edge of the recessed groove includes three rectilinear sides forming a recession.

6. The plug prong as claimed in claim 1, wherein the bottom edge of the recessed groove includes two slant sides extending downward and toward each other.

7. The plug prong as claimed in claim 1, wherein the recessed groove includes a slant side, an arcuate side opposite to the slant side, and a recessed arcuate bottom side interconnected between the slant side and the arcuate side.
